(19) United States
(12) Patent Application Publication
(10) Pub. No.: US 2008/0304202 A1
(43) Pub. Date: Dec. 11, 2008

(54) MULTI-LAYER CAPACITOR AND INTEGRATED CIRCUIT MODULE

(75) Inventor: Satoshi Kazama, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/132,540

(22) Filed: Jun. 3, 2008

(30) Foreign Application Priority Data
Jun. 4, 2007 (JP) 2007-147979
Jun. 3, 2008 (JP) 2008-145994

(51) Int. Cl. H01G 4/005

(52) U.S. Cl. 361/303

(57) ABSTRACT

It is intended to provide a multi-layer capacitor capable of obtaining good noise suppression characteristic at a high frequency band. The multi-layer capacitor has a structure that: a first conductor layer having a first extraction part connected to the first external electrode and a second extraction part connected to the second external electrode and a second conductor layer having a third extraction part connected to the third external electrode and a fourth extraction part connected to the fourth external electrode are alternately and integrally laminated via a dielectric layer; and each of the first conductor layers has a structure that two partial conductor layers are joined via a narrow part acting as an inductor, and each of the second conductor layers has a structure that two partial conductor layers are joined via a narrow part acting as an inductor.

### BACKGROUND OF THE INVENTION

1. Field of the Invention

This invention relates to a multi-layer capacitor suitably used for suppressing power supply line noise and a circuit device on which an integrated circuit is mounted.

2. Description of the Related Art

In a circuit substrate on which an integrated circuit is mounted, a multi-layer capacitor is used for suppressing power supply line noise caused by a noise current and the like leaked from a power supply terminal of the integrated circuit. Since the multi-layer capacitor outputs a low impedance at a high frequency, the multi-layer capacitor has functions such as suppressing the noise current leaked out to the circuit substrate. See for example, patent publication JP-A-10-154632.

One example of the multi-layer capacitor is shown in FIGS. 1A, 1B and 2, wherein FIG. 1A is a perspective view showing an appearance of the multi-layer capacitor; FIG. 1B is a diagram showing an equivalent circuit of the multi-layer capacitor shown in FIG. 1A; and FIG. 2 is a broken perspective view showing an internal structure of a main body shown in FIG. 1A.

A multi-layer capacitor 200 shown in the drawings is provided with a main body 201 in the form of a rectangular parallelepiped, first and second external electrodes 202 and 203 connected to a positive potential line of power supply lines provided on an obverse surface of the main body 201, and third and fourth external electrodes 204 and 205 connected to a ground potential line of the power supply lines.

The main body 201 has a structure wherein a first conductor layer 212 having a first extraction part 212a and a second extraction part 212b and a second conductor layer 213 having a third extraction part 213a and a fourth extraction part 213b are alternately and integrally laminated via a dielectric layer 211.

The first extraction part 212a is connected to the first external electrode 202, and the second extraction part 212b is connected to the second external electrode 203. The third extraction part 213a is connected to the third external electrode 204, and the fourth extraction part 213b is connected to the fourth external electrode 205.

Shown in FIG. 3 is one mounting example of the multi-layer capacitor 200 shown in FIG. 1A, wherein SB is a circuit substrate; PSP1 is a substrate power supply pattern; PSP2 is an IC power supply pattern; and SBG is a substrate ground pattern. Shown in FIG. 3 is a reverse surface of the circuit substrate SB on which an integrated circuit (not shown) is mounted, and a power supply terminal of the integrated circuit is connected to an IC power supply pattern (not shown) on an obverse surface that is in conduction with the IC power supply pattern PSP2 on the reverse surface, and a ground terminal of the integrated circuit is connected to a substrate ground pattern (not shown) of the obverse surface that is in conduction with the substrate ground pattern SBG2 on the reverse surface.

The first external electrode 202 of the multi-layer capacitor 200 is connected to the substrate power supply pattern PSP1; the second external electrode 203 is connected to the IC power supply pattern PSP2; and the third and fourth external electrodes 204 and 205 are connected to the substrate ground pattern SBG.

In the above-described mounting example of the multi-layer capacitor 200, a noise current leaked out from the power supply terminal of the integrated circuit flows into the first conductor layers 212 of the multi-layer capacitor 200 via the IC power supply pattern PSP2 to be bypassed to the substrate ground pattern SBG from the second conductor layers 213. Therefore, the noise of the power supply line caused by the noise current leaked to the substrate power supply pattern PSP1 is suppressed. Such suppressing characteristic depends on an impedance characteristic of the multi-layer capacitor. That is, the multi-layer capacitor acts as a serial resonant equalizer circuit by its capacity and parasitic inductance. Characteristic achieved by the capacitor capacity is predominant when the frequency is lower than the resonance point, and characteristic achieved by the equivalent series inductance (ESL) is predominant when the frequency is higher than the resonance point. Along with an increase in capacitor capacity or along with a reduction in ESL, the suppression characteristic is enhanced. Particularly, at the high frequency that is higher than the resonance point, the characteristic of the ESL decides the suppression characteristic.

FIG. 4 is a diagram showing the noise suppression characteristic according to the mounting example of FIG. 3, wherein the ESL in a state where the multi-layer capacitor 200 is mounted on the substrate is smaller than that of an ordinary multi-layer capacitor. Also, since the patterns are designed in accordance with the positions of the external electrodes 202 to 205 of the multi-layer capacitor 200, the capacitor is inserted on the noise current passage without fail, thereby making it possible to suppress an increase in ESL component of the capacitor otherwise caused by wirings of the substrate pattern. Further, thanks to the inductance components of the first and the second electrodes of the capacitor, the capacitor has another function of a T-shaped low-pass filter (LPF). Therefore, it is possible to enhance the noise suppression characteristic as compared to the case of using the ordinary multi-layer capacitor (see broken line in FIG. 4). Also, the characteristics between the first external electrode 202 and the third external electrode 204 and between the second external electrode 203 and the fourth external electrode 205 are similar to those of the ordinary multi-layer capacitor to suppress a ripple of a power supply terminal voltage.

### SUMMARY OF THE INVENTION

The characteristic of the above-described noise suppression effect at the frequency equal to or higher than the resonance point substantially depends on ESL of the mounted multi-layer capacitor 200. Since the ESL is decided by the shape of the multi-layer capacitor and the wiring pattern to be mounted, the power supply line noise suppression characteristic naturally has an upper limit.

In recent years, a frequency band of signals used in an integrated circuit has been diversified and raised. Therefore, influences exerted on wireless appliances by noises at frequencies of a radio, a television set, a mobile phone, and the like generated from these circuits have become a problem. In view of coexistence of the appliances to be achieved by a reduction in noise, there is a demand for a multi-layer capacitor having enhanced characteristic for suppressing the power supply line noise and an integrated circuit module using the multi-layer capacitor.

This invention has been accomplished in view of the above-described circumstances, and an object thereof is to provide a multi-layer capacitor capable of obtaining good noise suppression characteristic at a high frequency band and an integrated circuit module using the multi-layer capacitor.

In order to attain the above-described object, a multi-layer capacitor according to this invention comprises one of external circuits such as first and second external electrodes for connection to a voltage line of a DC power supply and the other external circuits such as third and fourth external electrodes for connection to a ground potential line provided on an obverse surface of a main body, wherein the main body has a structure that a first conductor layer having a first extraction part connected to the first external electrode and a second extraction part connected to the second external electrode and a second conductor layer having a third extraction part connected to the third external electrode and a fourth extraction part connected to the fourth external electrode are alternately and integrally laminated via a dielectric layer; and

at least one of the first and the second conductor layer has a structure that two or more partial conductor layers are joined via at least one narrow part.

This narrow portion means the part where narrowed a passage of an electric current in a conductor layer partially and extend a path of a electric current in a conductor by removing the conductor layer such as a slit which separates the first conductor layer and/or the second conductor layer.

It is possible that this narrow portion increase an inductance element between terminals.

Also, an integrated circuit module according to this invention comprises a circuit substrate provided with a substrate power supply pattern; an IC power supply pattern to which a power supply terminal of the integrated circuit is connected, a substrate ground pattern, and an IC ground pattern to which a ground terminal of the integrated circuit is connected; and the above-described multi-layer capacitor of which: a first external electrode is connected to the substrate power supply pattern of the circuit substrate; a second external electrode is connected to the IC power supply pattern; a third external electrode is connected to the substrate ground pattern; and a fourth external electrode is connected to the IC ground pattern.

According to a circuit device on which the multi-layer capacitor and the integrated circuit using the multi-layer capacitor are mounted, at least the first conductor layer among the first conductor layer and the second conductor layer has a structure that the two or more partial conductor layers are joined via at least one narrow part. Also, This narrow part increase more inductance as compared to a wider part. Also, thanks to the presence of the slit, an effect of lengthening a current passage inside the capacitor is achieved. Therefore, a characteristic similar to a π type low-pass filter (LPF) is exhibited between the extraction electrodes. Such characteristic contributes to a good power supply line noise suppression characteristic at a high frequency band as compared to the case of using an ordinary capacitor only. The capacitor described in the column of Description of Related Art is inserted only on the way of the current passage on the power supply side. In this invention, the connection enables the capacitor to be inserted on the way of the noise current passages on both of the power supply side and the ground side without fail. Further, due to the presence of the narrow part, a high LPF characteristic is achieved, and, therefore, it is possible to prevent the problems otherwise caused by the noise by appropriate suppression of power supply line noise in the case where a frequency band of signals used in the integrated circuit is diversified and raised. Particularly, the noise countermeasure effect at frequencies of wireless appliances is excellent.

Further, characteristics other than the noise suppression such as power supply ripple suppression of the capacitor having the above-described structure are scarcely or never changed, it is possible to use the capacitor in place of conventional capacitors.

According to this invention, it is possible to provide the multi-layer capacitor capable of obtaining good noise suppression characteristic at a high frequency band and the integrated circuit module using the multi-layer capacitor.

The above and other objects, structural characteristics, and effects of this invention will become apparent from the following description and accompanying drawings.

### BRIEF DESCRIPTION OF THE DRAWINGS

FIGS. 1A and 1B are diagrams showing a conventional multi-layer capacitor, wherein FIG. 1A is a perspective view showing an appearance of the multi-layer capacitor; and FIG. 1B is a diagram showing an equivalent circuit of the multi-layer capacitor shown in FIG. 1A.

FIG. 2 is a broken perspective view showing an internal structure of a main body shown in FIG. 1A.

FIG. 3 is a diagram showing one mounting example of the multi-layer capacitor shown in FIG. 1A.

FIG. 4 is a diagram showing the noise suppression characteristic according to the mounting example shown in FIG. 3.

FIGS. 5A and 5B are diagrams showing a multi-layer capacitor according to a first embodiment of this invention, wherein FIG. 5A is a perspective view showing an appearance of the multi-layer capacitor; and FIG. 5B is a diagram showing an equivalent circuit of the multi-layer capacitor shown in FIG. 5A.

FIG. 6 is a broken perspective view showing an internal structure of a main body shown in FIG. 5A.

FIG. 7 is a diagram showing a mounting example of the multi-layer capacitor shown in FIG. 5A.

FIG. 8 is a diagram shown the noise suppression characteristic achieved by the mounting example of FIG. 7.

FIG. 9 is a diagram showing an obverse surface of the circuit device on which the integrated circuit is mounted shown in FIG. 5A.

FIG. 10 is a diagram showing a reverse surface of the circuit device on which the integrated circuit module is mounted shown in FIG. 9.

FIG. 11 is a diagram showing a function circuit of the circuit device on which the integrated circuit module shown in FIGS. 9 and 10 is mounted.

FIG. 12 is a diagram showing an example of mounting the multi-layer capacitor shown in FIG. 5A to the DC-DC converter circuit device.

FIG. 13 is a diagram showing a function circuit of the circuit device on which the integrated circuit shown in FIG. 12 is mounted.

FIGS. 14A and 14B are diagrams showing a first modification example of the first and the second conductor layers shown in FIG. 6, wherein FIG. 14A is a top view showing the first conductor layer; and FIG. 14B is a top view of the second conductor layer.

FIGS. 15A and 15B are diagrams showing a second modification example of the first and the second conductor layers shown in FIG. 6, wherein FIG. 15A is a top view showing the first conductor layer; and FIG. 15B is a top view of the second conductor layer.

FIGS. 16A and 16B are diagrams showing a third modification example of the first and the second conductor layers shown in FIG. 6, wherein FIG. 16A is a top view showing the first conductor layer; and FIG. 16B is a top view of the second conductor layer.

FIGS. 17A to 17C are diagrams showing a fourth modification example of the first and the second conductor layers shown in FIG. 6, wherein FIG. 17A is a top view showing the first conductor layer; FIG. 17B is a top view of the second conductor layer; and

FIG. 17C is a diagram showing an equivalent circuit of a multi-layer capacitor obtained by using the first conductor layer and the second conductor layer shown in FIGS. 17A and 17B.

FIGS. 18A to 18C are diagrams showing a fifth modification example of the first conductor layer and the second conductor layer shown in FIG. 6, wherein FIG. 18A is a top view showing the first conductor layer; FIG. 18B is a top view of the second conductor layer; and FIG. 18C is a diagram showing an equivalent circuit of a multi-layer capacitor obtained by using the first conductor layer and the second conductor layer shown in FIGS. 18A and 18B.

FIGS. 19A to 19D are diagrams showing a sixth modification example of the first conductor layer and the second conductor layer shown in FIG. 6, wherein FIG. 19A is a top view showing the first conductor layer; FIG. 19B is a top view of the second conductor layer; FIG. 19C is a top view showing another example of the first conductor layer shown in FIG. 19A; and FIG. 19D is a top view showing another example of the second conductor layer shown in FIG. 19B.

FIGS. 20A and 20B are diagrams showing an eighth modification example of the first conductor layer and the second conductor layer shown in FIG. 6, wherein FIG. 20A is a top view showing the first conductor layer; FIG. 20B is a top view of the second conductor layer; and FIG. 20C is a perspective view showing an appearance of a multi-layer capacitor obtained by using the first and the second conductor layer shown in FIGS. 20A and 20B.

FIGS. 21A to 21D are diagrams showing a ninth modification example of the first conductor layer and the second conductor layer shown in FIG. 6, wherein FIG. 21A is a top view showing the first conductor layer; FIG. 21B is a top view of the second conductor layer; FIG. 21C is a perspective view showing an appearance of a multi-layer capacitor obtained by using the first and the second conductor layers shown in FIGS. 21A and 21B; and FIG. 21D is a diagram showing an equivalent circuit of the multi-layer capacitor shown in FIG. 21C.

FIGS. 22A and 22B are diagrams showing a tenth modification example of the first conductor layer and the second conductor layer shown in FIG. 6, wherein FIG. 22A is a top view showing the first conductor layer; and FIG. 22B is a top view of the second conductor layer.

FIGS. 23A to 23C are diagrams showing a twelfth modification example of the first conductor layer and the second conductor layer shown in FIG. 6, wherein FIG. 23A is a top view showing the first conductor layer; FIG. 23B is a top view of the second conductor layer; and FIG. 23C is a diagram showing an equivalent circuit of a laminated condense obtained by using the first conductor layer and the second conductor layer shown in FIGS. 23A and 23B.

FIGS. 24A and 24B are diagrams showing a thirteenth modification example of the first conductor layer and the second conductor layer shown in FIG. 6, wherein FIG. 24A is a top view showing the first conductor layer; and FIG. 24B is a top view of the second conductor layer.

FIGS. 25A and 25B are diagrams showing a fourteenth modification example of the first conductor layer and the second conductor layer shown in FIG. 6, wherein FIG. 25A is a top view showing the first conductor layer; and FIG. 25B is a top view of the second conductor layer.

FIGS. 26A and 26B are diagrams showing a multi-layer capacitor according to a second embodiment of this invention, wherein FIG. 26A is a perspective view showing an appearance of the multi-layer capacitor; and FIG. 26B is a diagram showing an equivalent circuit of the multi-layer capacitor shown in FIG. 26A.

FIG. 27 is a broken perspective view showing an internal structure of a main body shown in FIG. 26A.

FIG. 28 is a diagram showing a mounting example of the multi-layer capacitor shown in FIG. 26A.

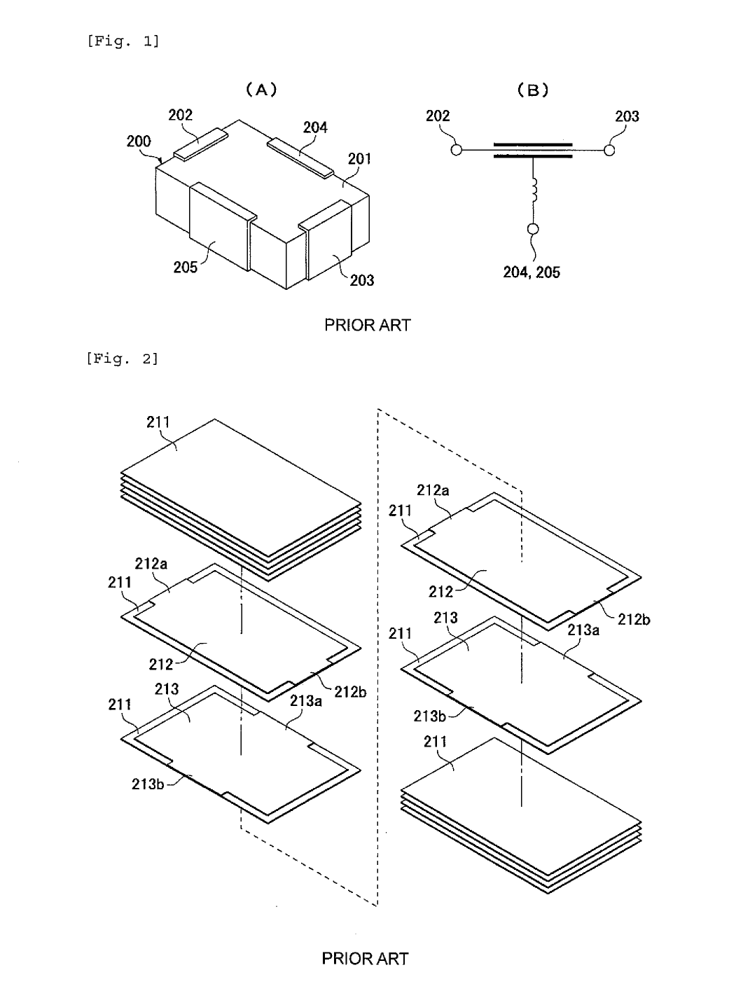

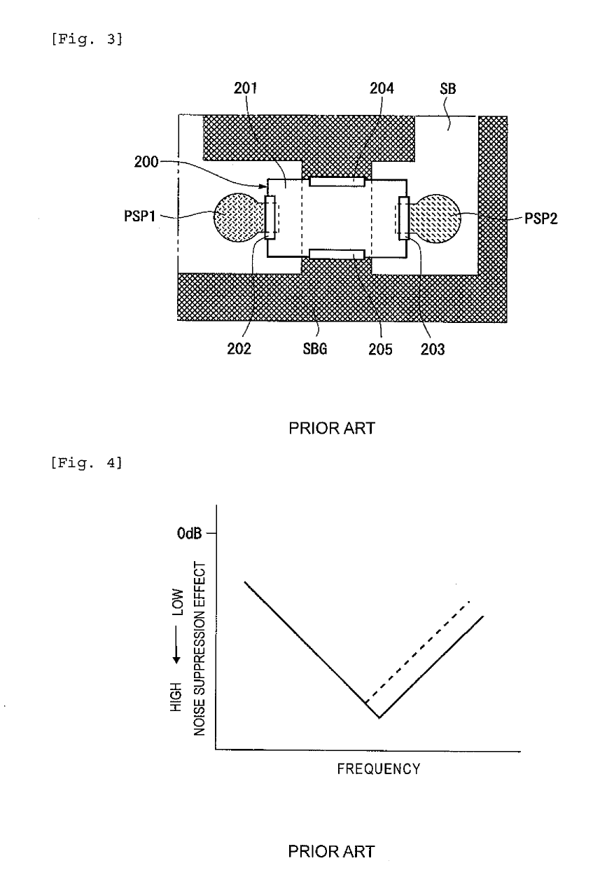

### DESCRIPTION OF THE PREFERRED EMBODIMENTS

### First Embodiment

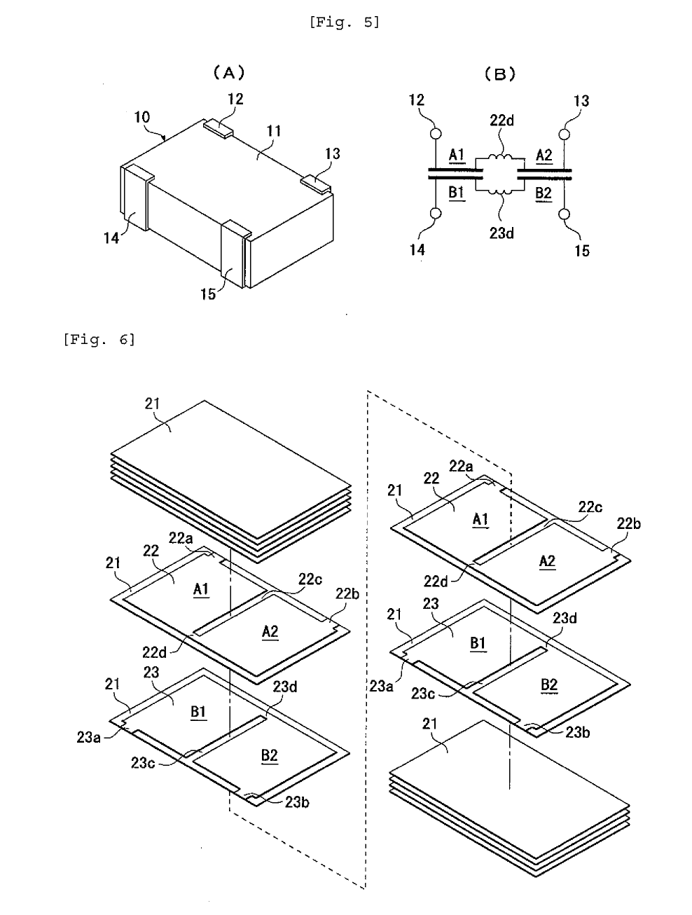

Shown in FIGS. 5A, 5B and 6 is a multi-layer capacitor, wherein FIG. 5A is a perspective view showing an appearance of the multi-layer capacitor; FIG. 5B is a diagram showing an equivalent circuit of the multi-layer capacitor shown in FIG. 5A; and FIG. 6 is a broken perspective view showing an internal structure of a main body shown in FIG. 5A.

A multi-layer capacitor 10 shown in FIG. 6 is provided with a main body 11 in the form of a rectangular parallelepiped having a predetermined length, a predetermined width, and a predetermined height; external circuits, such as a first external electrode 12 and a second external electrode 13, provided at one side in a width direction (short axis direction) of a surface of the main body 11 with a gap being defined therebetween in a length direction (long axis direction) and used for connection to one of direct current power supply circuits such as a positive potential line; and external circuits, such as a third external electrode 14 and a fourth external electrode 15, provided at the other side in the width direction of the surface of the main body in such a fashion as to face the first external electrode 12 and the second external electrode 13 and used for connection to the other one of the direct current power supply circuits such as a ground potential line. As to the connection to the external circuits, the same function is achieved when the pair of the first external electrode 12 and the second external electrode 13 and the pair of the third external electrode 14 and the fourth external electrode 15 are reversed.

The main body 11 has a structure wherein a first conductor layer 22 having a first extraction part 22a and a second extraction part 22b and a second conductor layer 23 having a third extraction part 23a and a fourth extraction part 23b are alternately and integrally laminated in a vertical direction via a dielectric layer 21. For example, dielectric layers on which 100 to 800 conductor layers are printed are laminated. The number of layers is decided depending on a capacity of the multi-layer capacitor to be obtained.

Each of the first conductor layers 22 has a rectangular shape having a predetermined length and a predetermined width, and the first extraction part 22a and the second extraction part 22b are provided on one side in a width direction of the first conductor layer 22 with a gap being defined therebetween in a length direction. In this embodiment, the first conductor layer has a rectangular shape wherein two rectangles are joined. Also, a slit 22c in the width direction is provided between the first extraction part 22a and the second extraction part 22b of the first conductor layer 22, specifically at the center in the length direction, and a narrow part 22d functioning as an inductor by the slit 22c in the width direction is provided on the other side in the width direction. The slit 22c enables positioning at the position dividing the rectangular first conductor layer into two rectangular first conductor layers. The first extraction part is connected to a positive potential side that is one of power supply lines of an integrated circuit IC, and the second extraction part is connected to a positive potential side of another circuit part of the integrated circuit IC power supply line.

Each of the second conductor layers 23 has a rectangular shape of the size identical to that of the first conductor layer 22, and the third extraction part 23a and the fourth extraction part 23b are provided on the other side in a width direction of the second conductor layer 23 with a gap being defined therebetween in a length direction. Also, a slit 23c in the width direction is provided between the third extraction part 23a and the fourth extraction part 23b of the second conductor layer, specifically at a position substantially corresponding in the length direction to the slit 22c in the width direction of the first conductor layer 22, and a narrow part 23d functioning as a part for increasing an inductance value by the slit 23c in the width direction is provided on one side in the width direction.

The third extraction part and the fourth extraction part of the second conductor layer 23 are connected to different ground potential sides of the integrated circuit IC power supply line, for example.

Each of the shapes of the first conductor layer and the second conductor layer is substantially rectangular since the maximum electrostatic capacitance is obtained by the shape.

The slit in this invention means a part having a relatively narrow width in which no electrode is disposed.

The narrow part 22d so functions as to increase an inductance value. Therefore, a position, a length, and a width of the narrow part 22d are decided in view of the inductance value to be set for required damping characteristic.

The maximum current amount to be fed to the capacitor is also decided by the presence of the narrow part. The position, the length, and the width of the narrow part 22d are decided by taking such feature also into consideration.

In this invention, since the multilayer structure of 100 to 800 layers is employed, the designing of inductance value and the decision of maximum current value are conducted in view of the number of layers.

In the same manner as in the designing of the length and the width of the narrow part 22d, a width and a length of the slit 22c are designed.

The positions of the slit 22c and the slit 23c may be varied in terms of designing. However, from the production point of view, the above-described center position is preferred. In view of the printing pattern, it is possible to suppress a production cost by the production using one pattern. Various position modifications may be considered, and, for example, it is possible to achieve a designing for enhancing the inductance by narrowing a current passage by providing the slits 22c and 23c on extraction part sides. Also, one of the points in terms of the designing is prevention of a reduction in opposed area between the first conductor layer 62 and the second conductor layer 63 by positioning the slits 22c and 23c on the parts of the first conductor layer 62 and the second conductor layer 63 that are identical with each other and forming the slits 22c and 23c having identical widths and identical lengths. Further, the width of the slits 22c and 23c may preferably be small as possible from the reason described above. Also, insofar as the function of the narrow part is not impaired, the length of the slits 22c and 23c may preferably be short as possible. As described above, careful notes are taken so as not to reduce the opposed area between the first conductor layer 62 and the second conductor layer 63.

The description of the narrow part 22c and the slit 23c has been given by way of representative description, and, since the narrow part and the slit described below are designed and put into practical use in the same manner, the same description will be omitted in the following.

Each of the first conductor layers 22 has a structure wherein partial conductor layers A1 and A2 each in the form of a rectangle are joined via one narrow part 22d having the inductance value increasing function, and each of the second conductor layers 23 has a structure wherein partial conductor layers B1 and B2 each in the form of a rectangle are joined via one narrow part 23d having the inductance value increasing function. Since each of the first extraction parts 22a is connected to the first external electrode 12; each of the second extraction parts 22b is connected to the second external electrode 13; each of the third extraction parts 23a is connected to the third external electrode 14; and each of the fourth extraction parts 23b is connected to the fourth external electrode 15, an equivalent circuit of the multi-layer capacitor 10 is as shown in FIG. 5B. The equivalent circuit exhibits the same characteristic as that of a four-terminal LPF, and characteristic between the first external electrode 12 and the third external electrode 14 or between the second external electrode 13 and the fourth external electrode 15 is the same as an ordinary multi-layer capacitor.

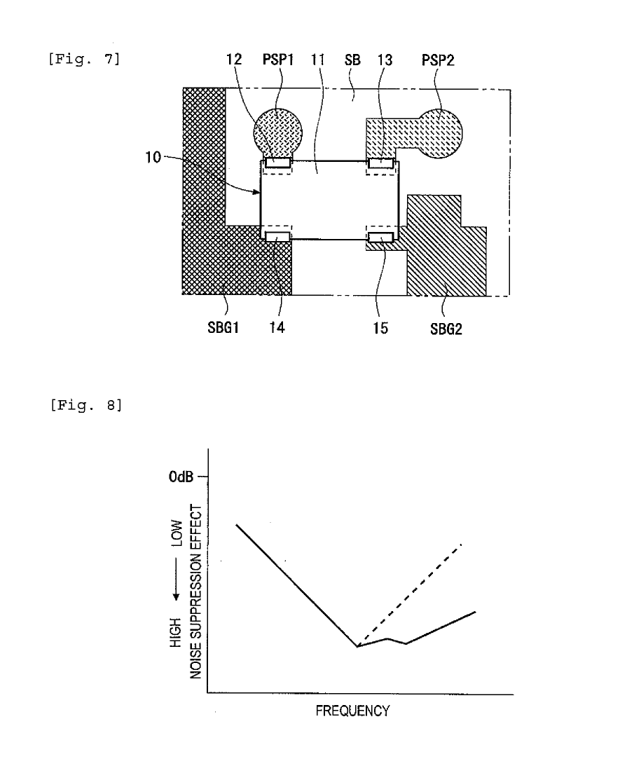

FIG. 7 is a diagram showing a mounting example of the multi-layer capacitor 10 shown in FIG. 5A, wherein SB is a circuit substrate; PSP1 is a substrate power supply pattern; PSP2 is an IC power supply pattern; and SBG1 is a substrate ground pattern, and SBG2 is an IC ground pattern. Shown in FIG. 7 is a reverse surface of the circuit substrate SB on which an integrated circuit (not shown) is mounted, and a power supply terminal of the integrated circuit is connected to an IC power supply pattern (not shown) on an obverse surface that is in conduction with the IC power supply pattern PSP2 on the reverse surface, and a ground terminal of the integrated circuit is connected to an IC ground pattern (not shown) of the obverse surface that is in conduction with the IC ground pattern SBG2 on the reverse surface. PSP1 and PSP2 and SBG1 and SBG2 are not electrically connected by the patterns on the substrate.

The first external electrode 12 of the multi-layer capacitor 10 is connected to the substrate power supply pattern PSP1; the second external electrode 13 is connected to the IC power supply pattern PSP2; and the third external electrode 14 is connected to the substrate ground pattern SBG1; and the fourth external electrode 15 is connected to the IC ground pattern SBG2.

In the mounting example of the multi-layer capacitor 10 shown in FIG. 7, a noise current leaked out from the power supply terminal of the integrated circuit IC flows into the second conductor layers 23 from the first conductor layers 12 of the multi-layer capacitor 10 via the integrated circuit IC power supply pattern PSP2 and the integrated circuit IC ground pattern SBG2 to be suppressed by filtering characteristic of the multi-layer capacitor 10. The suppression characteristic forms a π type LC filter exhibiting damping characteristic due to the provision of the function of intentionally increasing the inductance value in this invention. Further, in the multi-layer capacitor shown in FIGS. 1A and 1B, only the noise current at power supply side flows into the capacitor, but, since the noise current flowing to the ground also flows into the capacitor in this invention, the noises are simultaneously suppressed. Therefore, the characteristic exhibited by this invention is superior to that of the multi-layer capacitor 200 shown in FIG. 1A. Consequently, it is possible to suppress the power supply line noise generated by the noise current leaked to the substrate power supply pattern PSP1 and the substrate ground pattern SBG1.

FIG. 8 is a diagram showing the noise suppression characteristic achieved by the mounting example of FIG. 7. In the multi-layer capacitor 10, each of the first conductor layers 22 has the narrow part 22d functioning as an inductor; each of the second conductor layers 23 has the narrow part 23d functioning as an inductor; and characteristic equivalent to an LPF is exhibited as is apparent from the equivalent circuit of FIG. 5B. Since the first to fourth external electrodes 12 to 15 are inserted on the passage of the noise current without fail due to the patterns designed in accordance with the positions of the first to the fourth external electrodes 12 to 15, it is possible to obtain better noise suppression characteristic at a wider frequency band as compared to the case of using an ordinary capacitor (see broken line in FIG. 8).

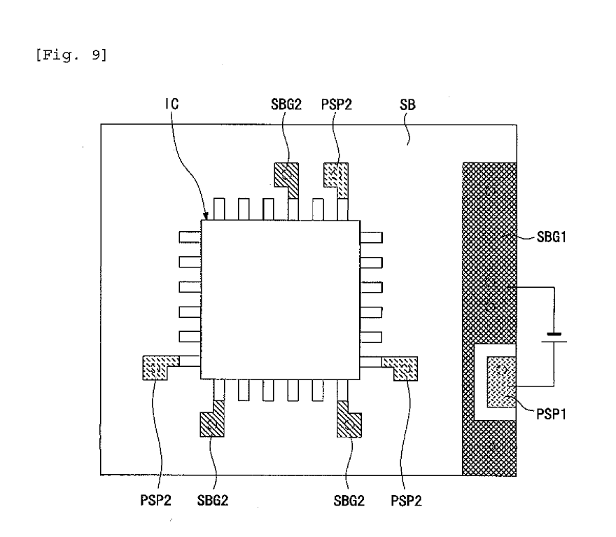

Shown in FIGS. 9 to 11 is one example of a circuit device on which the integrated circuit using the multi-layer capacitor 10 shown in FIG. 5A is mounted, wherein FIG. 9 is a diagram showing an obverse surface of the circuit device on which the integrated circuit is mounted; FIG. 10 is a diagram showing a reverse surface of the circuit device on which the integrated circuit is mounted; and FIG. 11 is a diagram showing a function circuit of the circuit device on which the integrated circuit shown in FIGS. 9 and 10 is mounted. The integrated circuit in this example has three power supply terminals and three ground terminals.

As shown in FIG. 9, the integrated circuit IC is mounted on the obverse surface of a circuit substrate SB; the power supply terminal of the integrated circuit IC is connected to an integrated circuit IC power supply pattern PSP2 provided on an obverse surface of the circuit substrate SB; and a ground terminal of the integrated circuit IC is connected to an integrated circuit IC ground pattern SBG2 provide on the obverse surface of the circuit substrate SB. Wirings to which other terminals of the integrated circuit IC are connected are omitted in the drawings.

As shown in FIG. 10, a reverse surface of the circuit substrate SB is provided with a substrate power supply pattern PSP1 connected via a through-hole to the substrate power supply pattern PSP1 on the obverse surface, a substrate ground pattern SBG1 connected via a through-hole (see a circle by broken line in the drawing) to the substrate ground pattern SBG1 on the obverse surface, an integrated circuit IC power supply pattern PSP2 connected via a through-hole (see a circle by broken line in the drawing) to the IC power supply pattern PSP2 on the obverse surface, and an integrated circuit IC ground pattern PSP2 connected via a through-hole (see a circle by broken line in the drawing) to the integrated circuit IC ground pattern SBG2 on the obverse surface.

In the circuit device on which the integrated circuit is mounted, the number of the multi-layer capacitors 10 mounted on the reverse surface of the circuit substrate SB is three. Connection objects of the first to the fourth external electrodes 12 to 15 of each of the multi-layer capacitors 10 are the same as those described by using FIG. 7, and descriptions thereof are omitted in this example.

As described above, according to the circuit device on which the above-described multi-layer capacitor 10 and the integrated circuit using the multi-layer capacitor 10 are mounted, since the narrow part 22d is provided as the function of increasing the inductance value on each of the first conductor layers 22, and since the narrow part 23d is provided as the function of increasing the inductance value on each of the second conductor layers 23, it is possible to perform good power supply line noise suppression thanks to the presence of the narrow parts 22d and 23d. Therefore, it is possible to prevent the problems otherwise caused by the noise by appropriately performing the desired power supply line noise suppression even in the case where the frequency band of signals used in the integrated circuit IC is diversified and raised.

Also, according to the circuit device on which the integrated circuit is mounted, since the substrate power supply pattern PSP1, the integrated circuit IC power supply pattern PSP2, the substrate ground pattern SBG1, and the integrated circuit IC ground pattern SBG2 are provided corresponding to the first to the fourth external electrodes 12 to 15 of the multi-layer capacitor 10, it is possible to insert the multi-layer capacitor 10 without fail on the passage on which all the noises are leaked out. In an ordinary two-terminal multi-layer capacitor, it is possible to allocate the capacitor on a part other than the passage of the noise current, and there is a possibility of deterioration of noise suppression characteristic caused by such allocation. In the circuit device on which the integrated circuit of this invention is mounted, such deterioration is avoided.

In the circuit device shown in FIGS. 9 and 10 on which the integrated circuit device is mounted, though the integrated circuit operating by externally supplied power is used, the example is applicable to a power supply circuit device such as a CD-CD converter.

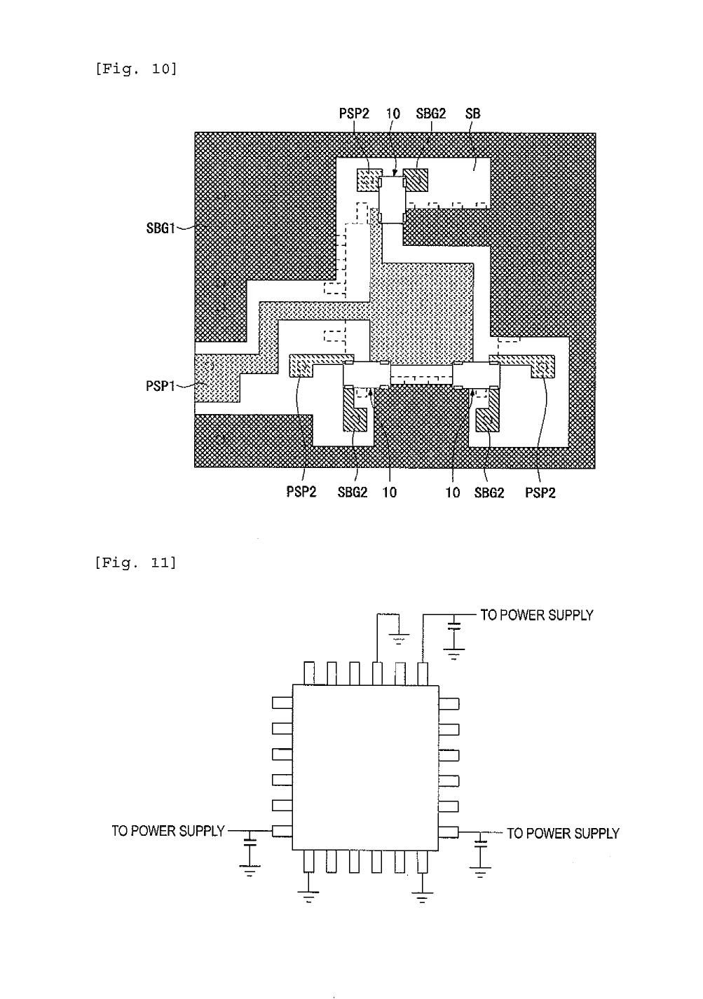

Shown in FIGS. 12 and 13 is one example of a circuit device on which the integrated circuit using the multi-layer capacitor 10 shown in FIG. 5A is mounted, wherein FIG. 12 is a diagram showing an obverse surface of the circuit device on which the integrated circuit is mounted, and no circuit is formed on a reverse surface; and FIG. 13 is a diagram showing a function circuit of the circuit device on which the integrated circuit shown in FIG. 12 is mounted. This example is one example of a step-down DC/DC converter wherein the multi-layer capacitor 10 serving as a condenser is provided at an input side; and the multi-layer capacitor 10 is provided as an inductor at an output side and another capacitor at the output side.

As shown in FIG. 12, a DC-DC converter integrated circuit IC, an output inductor, an input capacitor, and an output capacitor are mounted on an obverse surface of a circuit substrate SB. The circuit substrate is provided with a first substrate power supply pattern to which power of 5 v is supplied, a second substrate power supply pattern from which a voltage of 1 V is extracted, an IC ground pattern to which a substrate ground pattern IC is connected, a first IC power supply pattern connected to the 5V input terminal of the IC, a connection pattern connecting the IC and the output inductor, and a second IC power supply pattern connected to the output inductor are provided. The patterns are not electrically connected before mounting the components.

In the circuit device on which the integrated circuit is mounted, the first IC power supply pattern is connected to a first external electrode; the first substrate power supply pattern is connected to a second external electrode; the IC ground pattern is connected to a third external electrode; and the substrate ground pattern is connected to a fourth external electrode in the multi-layer capacitor 10 at the input side, and the second IC power supply pattern is connected to a first external electrode; the second substrate power supply pattern is connected to a second external electrode; the IC ground pattern is connected to a third external electrode; and the substrate ground pattern is connected to a fourth external electrode in the multi-layer capacitor 10 at the output side.

According to the circuit device on which the multi-layer capacitor 10 and the integrated circuit using the multi-layer capacitor 10 are mounted, since the narrow part 22d is provided as a function of increasing the inductance value on each of the first conductor layers 22, and since the narrow part 23d is provided as a function of increasing the inductance value on each of the second conductor layers 23, it is possible to suppress a switching noise generated from the DC-DC converter integrated circuit IC from flowing into the substrate by the presence of the narrow parts 22d and 23d. Since the noise is generated in a wide frequency band, it is possible to prevent the problems caused by the noise by appropriately suppressing the noise.

### First Modification Example of First and Second Conductor Layers

FIGS. 14A and 14B are diagrams showing a first modification example of the first conductor layer and the second conductor layer shown in FIG. 6, wherein FIG. 14A is a top view showing the first conductor layer; and FIG. 14B is a top view of the second conductor layer.

The first conductor layer 32 has a rectangular shape having a predetermined length and a predetermined width and provided with a first extraction part 32a and a second extraction part 32b disposed at one side in a width direction of the first conductor layer 32 with a gap being defined therebetween in a length direction. Also, a slit 32c in the width direction is provided between the first extraction part 32a and the second extraction part 32b of the first conductor layer 32, specifically at the center in the length direction, and a narrow part 32d as a function for increasing an inductance value by the slit 32c in the width direction is provided on one side in the width direction.

The second conductor layer 33 has a rectangular shape of the size identical to that of the first conductor layer 32, and a third extraction part 33a and a fourth extraction part 33b are provided on the other side in a width direction of the second conductor layer 33 with a gap being defined therebetween in a length direction. Also, a slit 33c in the width direction is provided between the third extraction part 33a and the fourth extraction part 33b of the second conductor layer 33, specifically at a position substantially corresponding in the length direction to the slit 32c in the width direction of the first conductor layer 32, and a narrow part 33d is provided as a function for increasing an inductance value by the slit 33c in the width direction on the other side in the width direction. The positions of the slits 32c and 33c may be varied from the designing point of view. However, the center position is preferred from the production point of view. It is possible to modify the slit 32c and the slit 33c in the same manner as described above.

The first conductor layer 32 has a structure wherein two partial conductor layers A1 and A2 each having a rectangular shape are joined via the narrow part 32d having the inductance value increasing function, and the second conductor layer 33 has a structure wherein two partial conductor layers B1 and B2 each having a rectangular shape are joined via the narrow part 33d having the inductance value increasing function. A dielectric layer is denoted by 31.

It is possible to obtain a multi-layer capacitor having an equivalent circuit same as that shown in FIG. 5B by using the first conductor layer 32 and the second conductor layer 33 in place of the first conductor layer 22 and the second conductor layer 23 shown in FIG. 6, and the multi-layer capacitor achieves the effects same as those of the circuit device described in the foregoing, on which the multi-layer capacitor 10 and the integrated circuit are mounted.

### Second Modification Example of First and Second Conductor Layers

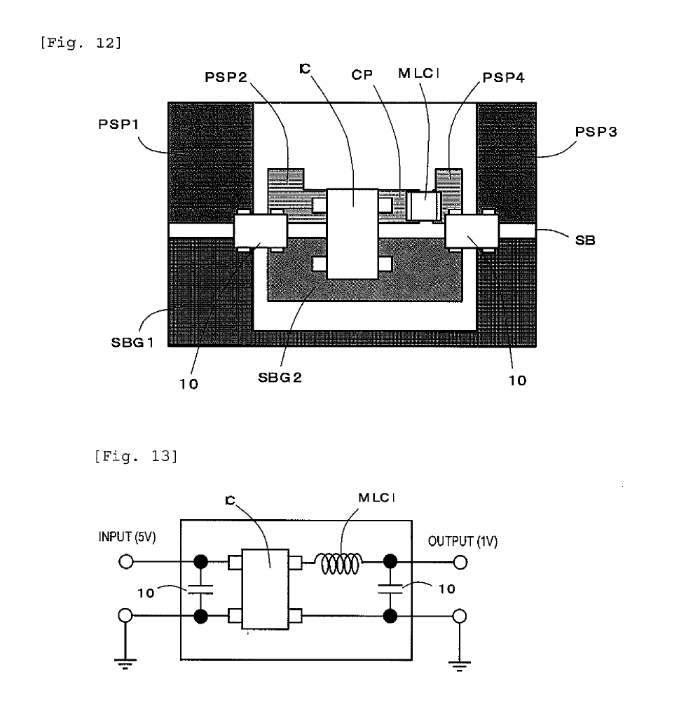

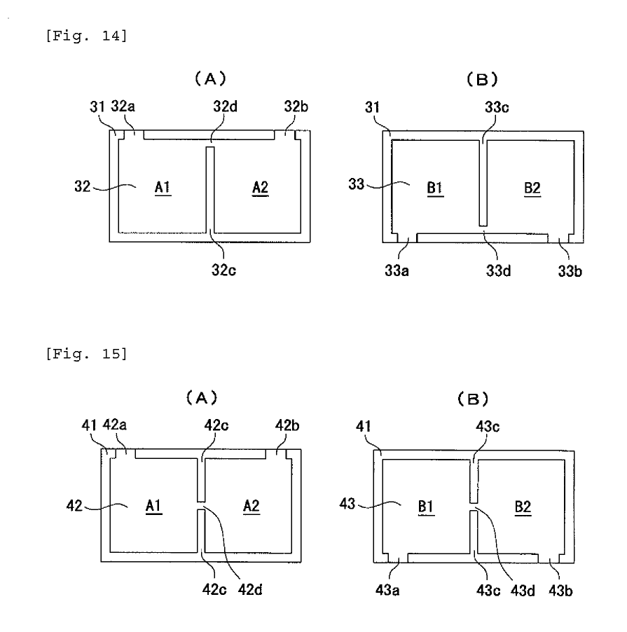

FIGS. 15A and 15B are diagrams showing a second modification example of the first conductor layer and the second conductor layer shown in FIG. 6, wherein FIG. 15A is a top view showing the first conductor layer; and FIG. 15B is a top view of the second conductor layer.

The first conductor layer 42 has a rectangular shape having a predetermined length and a predetermined width and provided with a first extraction part 42a and a second extraction part 42b disposed at one side in a width direction of the first conductor layer 42 with a gap being defined therebetween in a length direction. Also, two opposed slits 42c in the width direction are provided between the first extraction part 42a and the second extraction part 42b of the first conductor layer 42, specifically at the center in the length direction, and a narrow part 42d having a function of increasing an inductance value by the slits 42c in the width direction is provided at the center in the width direction.

The second conductor layer 43 has a rectangular shape of the size identical to that of the first conductor layer 42, and a third extraction part 43a and a fourth extraction part 43b are provided on the other side in a width direction of the second conductor layer 43 with a gap being defined therebetween in a length direction. Also, two opposed slits 43c in the width direction are provided between the third extraction part 43a and the fourth extraction part 43b of the second conductor layer 43, specifically at positions substantially corresponding in the length direction to the slits 42c in the width direction of the first conductor layer 42, and a narrow part 43d having a function of increasing an inductance value by the slits 43c in the width direction is provided at the center in the width direction. The position in the length direction and the position in the width direction of the narrow part 43d are substantially identical with those of the narrow part 42d of the first conductor layer 42.

In this case, the narrow part 42d of the first conductor layer and the narrow part 43d of the second conductor layer generate magnetic bonding. Therefore, a function similar to that of a common mode chalk coil is exhibited so that great suppression of a common mode noise is achieved.

The positions of the slits 42c and 43c may be varied from the designing point of view. However, the center position is preferred from the production point of view. It is possible to modify the slit 42c and the slit 43c in the same manner as described above.

The first conductor layer 42 has a structure wherein two partial conductor layers A1 and A2 each having a rectangular shape are joined via the narrow part 42d having the inductance value increasing function, and the second conductor layer 43 has a structure wherein two partial conductor layers B1 and B2 each having a rectangular shape are joined via the narrow part 43d having the inductance value increasing function. A dielectric layer is denoted by 41.

It is possible to obtain a multi-layer capacitor having an equivalent circuit same as that shown in FIG. 5B by using the first conductor layer 42 and the second conductor layer 43 in place of the first conductor layer 22 and the second conductor layer 23 shown in FIG. 6, and the multi-layer capacitor achieves the effects same as those of the circuit device described in the foregoing, on which the multi-layer capacitor 10 and the integrated circuit are mounted.

### Third Modification Example of First and Second Conductor Layers

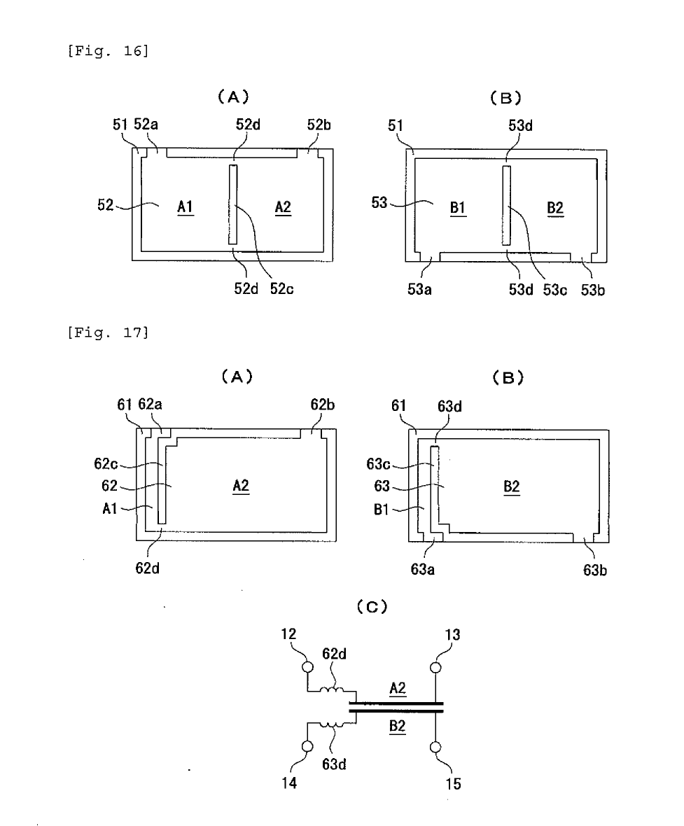

FIG. 16 is a diagram showing a third modification example of the first conductor layer and the second conductor layer shown in FIG. 6, wherein FIG. 16A is a top view showing the first conductor layer; and FIG. 16B is a top view of the second conductor layer.

The first conductor layer 52 has a rectangular shape having a predetermined length and a predetermined width and provided with a first extraction part 52a and a second extraction part 52b disposed at one side in a width direction of the first conductor layer 52 with a gap being defined therebetween in a length direction. Also, a slit 52c in the width direction is provided between the first extraction part 52a and the second extraction part 52b of the first conductor layer 52, specifically at the center in the length direction, and two narrow parts 52d as a function of increasing an inductance value by the slit 52c in the width direction are provided on both sides in the width direction.

The second conductor layer 53 has a rectangular shape of the size identical to that of the first conductor layer 52, and a third extraction part 53a and a fourth extraction part 53b are provided on the other side in a width direction of the second conductor layer 53 with a gap being defined therebetween in a length direction. Also, a slit 53c in the width direction is provided between the third extraction part 53a and the fourth extraction part 53b of the second conductor layer 53, specifically at a position substantially corresponding in the length direction to the slit 52c in the width direction of the first conductor layer 52, and two narrow parts 53d having a function of increasing an inductance value by the slit 53c in the width direction is provided on both sides in the width direction. The positions in the length direction and the positions in the width direction of the two narrow parts 53d are substantially identical with those of the two narrow parts 52d of the first conductor layer 52.

Other modifications may be made with reference to the foregoing description.

The first conductor layer 52 has a structure wherein two partial conductor layers A1 and A2 each having a rectangular shape are joined via the two narrow parts 52d having the inductance value increasing function, and the second conductor layer 53 has a structure wherein two partial conductor layers B1 and B2 each having a rectangular shape are joined via the two narrow parts 53d having the inductance value increasing function. A dielectric layer is denoted by 51.

It is possible to obtain a multi-layer capacitor having an equivalent circuit same as that shown in FIG. 5B by using the first conductor layer 52 and the second conductor layer 53 in place of the first conductor layer 22 and the second conductor layer 23 shown in FIG. 6, and the multi-layer capacitor achieves the effects same as those of the circuit device described in the foregoing, on which the multi-layer capacitor 10 and the integrated circuit are mounted.

### Fourth Modification Example of First and Second Conductor Layers

FIGS. 17A to 17C are diagrams showing a fourth modification example of the first conductor layer and the second conductor layer shown in FIG. 6, wherein FIG. 17A is a top view showing the first conductor layer; FIG. 17B is a top view of the second conductor layer; and FIG. 17C is a diagram showing an equivalent circuit of a multi-layer capacitor obtained by using the first conductor layer and the second conductor layer shown in FIGS. 17A and 17B. That is, one specific modification example of the mode described above.

The first conductor layer 62 has a rectangular shape having a predetermined length and a predetermined width and provided with a first extraction part 62a and a second extraction part 62b disposed at one side in a width direction of the first conductor layer 62 with a gap being defined therebetween in a length direction. Also, a slit 62c in the width direction is provided between the first extraction part 62a and the second extraction part 62b of the first conductor layer 62, specifically at a position close to the first extraction part 62a, and a narrow part 62d having a function of increasing an inductance value by the slit 62c in the width direction is provided on the other side in the width direction.

The second conductor layer 63 has a rectangular shape of the size identical to that of the first conductor layer 62, and a third extraction part 63a and a fourth extraction part 63b are provided on the other side in a width direction of the second conductor layer 63 with a gap being defined therebetween in a length direction. Also, a slit 63c in the width direction is provided between the third extraction part 63a and the fourth extraction part 63b of the second conductor layer 63, specifically at a position substantially corresponding in the length direction to the slit 62c in the width direction of the first conductor layer 62, and a narrow part 63d having an inductance value increasing function by the slit 63c in the width direction is provided on one side in the width direction.

The first conductor layer 62 has a structure wherein two partial conductor layers A1 and A2 each having a rectangular shape are joined via the narrow part 62d having the inductance value increasing function, and the second conductor layer 63 has a structure wherein two partial conductor layers B1 and B2 each having a rectangular shape are joined via the narrow part 63d having the inductance value increasing function. A dielectric layer is denoted by 61.

Other modifications may be made with reference to the foregoing description.

In the case of using the first conductor layer 62 and the second conductor layer 63 in place of the first conductor layer 22 and the second conductor layer 23 shown in FIG. 6, the equivalent circuit of the multi-layer capacitor to be obtained is as shown in FIG. 15C since the partial conductor layer A1 and the partial conductor layer B1 have the elongated shape and the smaller opposed area. However, the multi-layer capacitor achieves the effects same as those of the circuit device described in the foregoing, on which the multi-layer capacitor 10 and the integrated circuit are mounted.

The idea of providing the slit 62c in the width direction of the first conductor layer 62 at the position close to the first extraction part 62a and providing the slit 63c in the width direction of the second conductor layer 63 close to the third extraction part 63a is applicable to the first conductor layer 22 and the second conductor layer 23 shown in FIG. 6, the first conductor layer and the second conductor layer of the first to the third modification examples, and the first conductor layer of the fifth embodiment described later in this specification.

### Fifth Modification Example of First and Second Conductor Layers

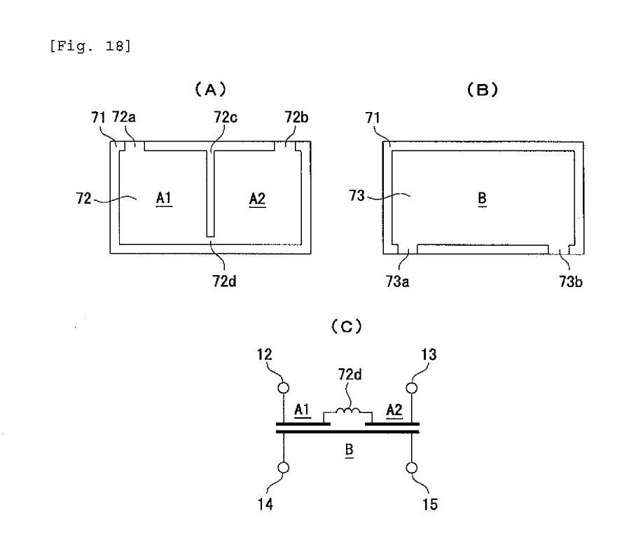

FIGS. 18A to 18C are diagrams showing a fifth modification example of the first conductor layer and the second conductor layer shown in FIG. 6, wherein FIG. 18A is a top view showing the first conductor layer; FIG. 18B is a top view of the second conductor layer; and FIG. 18C is a diagram showing an equivalent circuit of a multi-layer capacitor obtained by using the first conductor layer and the second conductor layer shown in FIGS. 18A and 18B.

The first conductor layer 72 has a rectangular shape having a predetermined length and a predetermined width and provided with a first extraction part 72a and a second extraction part 72b disposed at one side in a width direction of the first conductor layer 72 with a gap being defined therebetween in a length direction. Also, a slit 72c in the width direction is provided between the first extraction part 72a and the second extraction part 72b of the first conductor layer 72, specifically at the center in the length direction, and a narrow part 72d having a function of increasing an inductance value by the slit 72c in the width direction is provided on the other side in the width direction.

The second conductor layer 73 has a rectangular shape of the size identical to that of the first conductor layer 72, and a third extraction part 73a and a fourth extraction part 73b are provided on the other side in a width direction of the second conductor layer 73 with a gap being defined therebetween in a length direction. On the second conductor layer 73, the slit in the width direction and the narrow part of the first conductor layer 72 are not provided.

The first conductor layer 72 among the first conductor layer 72 and the second conductor layer 73 has a structure wherein two partial conductor layers A1 and A2 each having a rectangular shape are joined via the narrow part 72d having the inductance value increasing function A dielectric layer is denoted by 71.

Other modifications may be made with reference to the foregoing description.

In the case of using the first conductor layer 72 and the second conductor layer 73 in place of the first conductor layer 22 and the second conductor layer 23 shown in FIG. 6, the equivalent circuit of the multi-layer capacitor to be obtained is as shown in FIG. 16C since the narrow part having the inductance value increasing function is not provided on the second conductor layer 73. However, the multi-layer capacitor achieves the effects same as those of the circuit device described in the foregoing, on which the multi-layer capacitor 10 and the integrated circuit are mounted.

### Sixth Modification Example of First and Second Conductor Layers

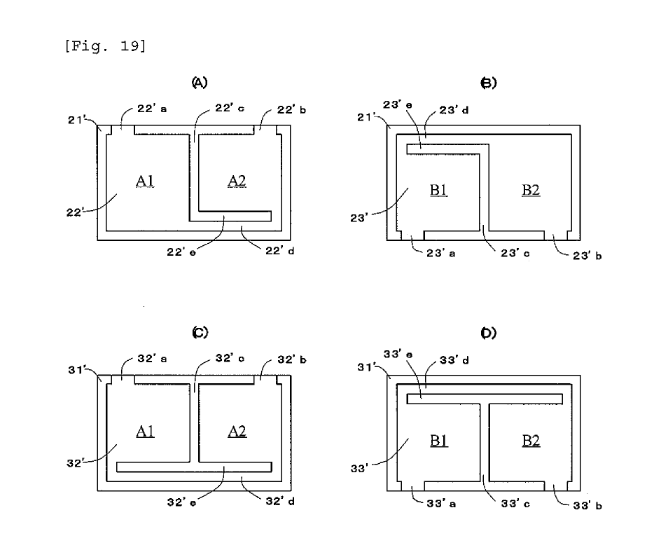

FIGS. 19A to 19C are diagrams showing a sixth modification example of the first conductor layer and the second conductor layer shown in FIG. 6, wherein FIG. 19A is a top view showing the first conductor layer; FIG. 19B is a top view of the second conductor layer; FIG. 19C is a top view showing another example of the first conductor layer shown in FIG. 19A; and FIG. 19D is a top view showing another example of the second conductor layer shown in FIG. 19B.

The modification example of FIGS. 19A and 19B will firstly be described. The first conductor layer 22′ has a rectangular shape having a predetermined length and a predetermined width and provided with a first extraction part 22′a and a second extraction part 22′b disposed at one side in a width direction of the first conductor layer 22′ with a gap being defined therebetween in a length direction. Also, a slit 22′c in the width direction is provided between the first extraction part 22′a and the second extraction part 22′b of the first conductor layer 22′, specifically at the center in the length direction, and a slit 22′e in the length direction is provided continuously with the slit 22′c in the width direction to form a substantially L-shaped slit. A narrow part 22′d having a function of increasing an inductance value by the slit 22′c in the width direction and the slit 22′e in the length direction is provided on the other side in the width direction.

The second conductor layer 23′ has a rectangular shape of the size identical to that of the first conductor layer 22′, and a third extraction part 23′a and a fourth extraction part 23′b are provided on the other side in a width direction of the second conductor layer 23′ with a gap being defined therebetween in a length direction. Also, a slit 23′c in the width direction is provided between the third extraction part 23′a and the fourth extraction part 23′b of the second conductor layer 23′, specifically at a position substantially corresponding in the length direction to the slit 22′c in the width direction of the first conductor layer 22′ and a slit 23′e in the length direction is provided continuously with the slit 23′c in the width direction to form a substantially L-shaped slit. A narrow part 23′d having a function of increasing an inductance value by the slit 23′c in the width direction and the slit 23′e in the length direction is provided on one side in the width direction.

Other modifications may be made with reference to the foregoing description.

The first conductor layer 22′ has a structure wherein two partial conductor layers A1 and A2 each having a rectangular shape are joined via the narrow part 22′d having the inductance value increasing function, and the second conductor layer 23′ has a structure wherein two partial conductor layers B1 and B2 each having a rectangular shape are joined via the narrow part 23′d having the inductance value increasing function. A dielectric layer is denoted by 21′.

Hereinafter, another example will be described based on the modification example of FIGS. 19C and 19D. The feature of the first conductor layer 32′ different from the first conductor layer 22′ is that a slit 32′c in the width direction and a slit 32′e in the length direction are continuous to form a substantially T-shape. A narrow part 32′d having a function of increasing an inductance value by the slit 32′c in the width direction and the slit 32′e in the length direction is provided over a wide area at the other side in the width direction.

The feature of the second conductor layer 33′ different from the second conductor layer 23′ is that a slit 33′c in the width direction and a slit 33′e in the length direction are continuous to form a substantially T-shape. A narrow part 33′d having a function of increasing an inductance value by the slit 33′c in the width direction and the slit 33′e in the length direction is provided over a wide area at the other side in the width direction.

The first conductor layer 32′ has a structure wherein two partial conductor layers A1 and A2 each having a rectangular shape are joined via the narrow part 32′d having the inductance value increasing function, and the second conductor layer 33′ has a structure wherein two partial conductor layers B1 and B2 each having a rectangular shape are joined via the narrow part 33′d having the inductance value increasing function. A dielectric layer is denoted by 31′.

In the case of using the first conductor layer 22′ and the second conductor layer 23′ or the first conductor layer 32′ and the second conductor layer 33′ in place of the first conductor layer 22 and the second conductor layer 23 shown in FIG. 6, it is possible to obtain a multi-layer capacitor having an equivalent circuit same as that of the FIG. 5B, and the multi-layer capacitor achieves the effects same as those of the multi-layer capacitor 10 and the integrated circuit described in the foregoing. Note that it is possible to obtain a larger inductance value in this modification example since the narrow part 23′d and the narrow part 33′d are longer than the narrow part 22d shown in FIG. 6.

### Seventh Modification Example of First and Second Conductor Layers

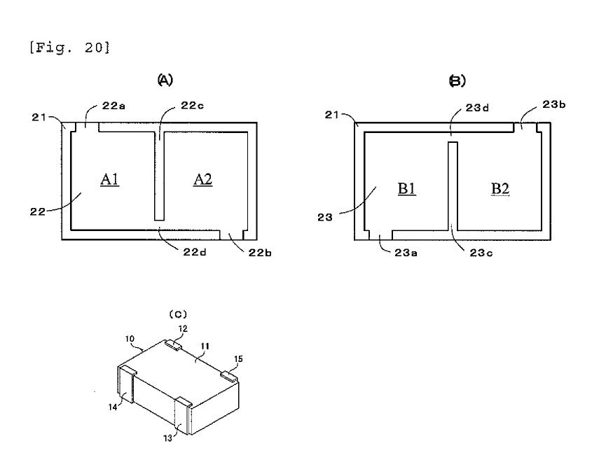

FIGS. 20A to 20C are diagrams showing an eighth modification example of the first conductor layer and the second conductor layer shown in FIG. 6, wherein FIG. 20A is a top view showing the first conductor layer; and FIG. 20B is a top view of the second conductor layer.

The differences between the first conductor layer and the second conductor layer of this modification example and the first conductor layer and the second conductor layer shown in FIG. 6 are such that the first extraction part 22a in the first conductor layer 22 is provided at one side in the width direction and one side in the length direction of a first conductor layer 82 and that the second extraction part 22b is provided at the other side in the width direction and the other side in the length direction of the first conductor layer 22. Also, in the second conductor layer 23, the third extraction part 23a is provided in the other side in the width direction and one side in the length direction of the second conductor layer 23, and that the fourth extraction part 23b is provided at one side in the width direction and the other side in the length direction of the second conductor layer 23.

Other modifications may be made with reference to the foregoing description.

Since the position of the second extraction part 22b and the position of the fourth extraction part 23b are replaced with each other in the case of using the first conductor layer 22 and the second conductor layer 23, the positions of the second external electrode 13 and the fourth external electrode 15 are replaced with each other as shown in FIG. 20C. As described above, the first extraction part 22a and the second extraction part 22b of the first conductor layer 22 and the third extraction part 23a and the fourth extraction part 23b of the second conductor layer 23 may be formed on different surfaces. Referring to FIG. 20, though the extraction parts are so formed as to be extracted to opposed sides, they may be so formed as to be extracted to adjacent sides. Such multi-layer capacitor is capable of obtaining a multi-layer capacitor having an equivalent circuit same as that of FIG. 5B, and it is possible to achieve the effects same as those of the circuit device described in the foregoing, on which the multi-layer capacitor 10 and the integrated circuit are mounted. This modification example is applicable of course to the first to the sixth modification examples as well as to the eights to twelfth modification examples described later in this specification.

### Eighth Modification Example of First and Second Conductor Layers

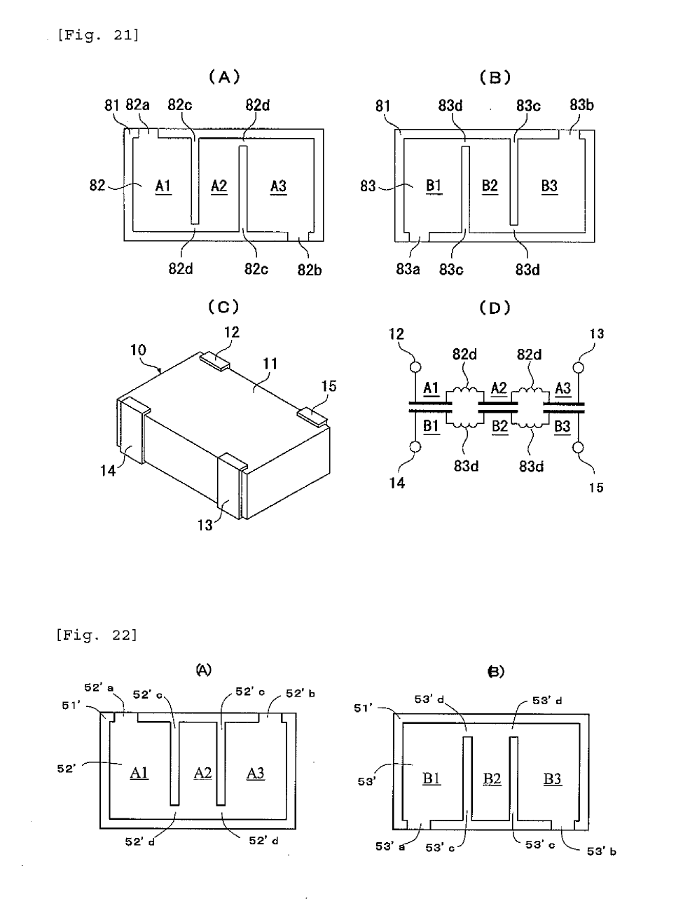

FIGS. 21A to 21D are diagrams showing a sixth modification example of the first conductor layer and the second conductor layer shown in FIG. 6, wherein FIG. 21A is a top view showing the first conductor layer; FIG. 21B is a top view of the second conductor layer; FIG. 21C is a perspective view showing an appearance of a multi-layer capacitor obtained by using the first and the second conductor layers shown in FIGS. 21A and 21B; and FIG. 21D is a diagram showing an equivalent circuit of the multi-layer capacitor shown in FIG. 21C.

The first conductor layer 82 has a rectangular shape having a predetermined length and a predetermined width, wherein a first extraction part 82a is disposed at one side in a width direction and one side in a length direction of the first conductor layer 82; and a second extraction part 82b is disposed at the other side in the width direction and the other side in the length direction of the first conductor layer 82. Also, two slits 82c in the width direction are provided between the first extraction part 82a and the second extraction part 82b of the first conductor layer 82, specifically at positions with a gap being defined therebetween in the length direction, and two narrow parts 82d having a function of increasing an inductance value by the slits 82c in the width direction are provided on the other side in the width direction and one side in the width direction in this order.

The second conductor layer 83 has a rectangular shape of the size identical to that of the first conductive layer 82, and a third extraction part 83a is disposed at the other side in a width direction and one side in a length direction of the second conductor layer 83; and a fourth extraction part 83b is disposed at one side in the width direction and the other side in the length direction of the second conductor layer 83. Also, two slits 83c in the width direction are provided between the third extraction part 83a and the fourth extraction part 83b of the second conductor layer 83, specifically at positions with a gap being defined therebetween in the length direction, and two narrow parts 83d having a function of increasing an inductance value by the slits 83c in the width direction are provided on one side in the width direction and the other side in the width direction in this order.

The first conductor layer 82 has a structure wherein three partial conductor layers A1, A2, and A3 each having a rectangular shape are joined with the narrow part 82d having the inductance value increasing function being formed between the adjacent partial conductor layers, and the second conductor layer 83 has a structure wherein three partial conductor layers B1, B2, and B3 each having a rectangular shape are joined with the narrow part 83d having the inductance value increasing function being formed between the adjacent partial conductor layers. A dielectric layer is denoted by 81.

Since the position of the second extraction part 82b and the position of the fourth extraction part 83b are replaced with each other in the case of using the first conductor layer 82 and the second conductor layer 83 in place of the first conductor layer 22 and the second conductor layer 23 shown in FIG. 6, the positions of the second external electrode 13 and the fourth external electrode 15 are replaced with each other as shown in FIG. 21C. In this case, an equivalent circuit of the thus-obtained multi-layer capacitor is the one shown in FIG. 21D since each of the first conductor layer 82 and the second conductor layer 83 has the two narrow parts 82d and 83d, and such multi-layer capacitor is capable of achieving the effects same as those of the multi-layer capacitor 10 and the integrated circuit described in the foregoing.

### Ninth Modification Example of First and Second Conductor Layers

FIGS. 22A and 22B are diagrams showing a tenth modification example of the first conductor layer and the second conductor layer shown in FIG. 6, wherein FIG. 22A is a top view showing the first conductor layer; and FIG. 22B is a top view of the second conductor layer.

The first conductor layer 52′ has a rectangular shape having a predetermined length and a predetermined width and provided with a first extraction part 52′a and a second extraction part 52′b disposed at one side in a width direction of the first conductor layer 52′ with a gap being defined therebetween in a length direction. Also, two slits 52′c in the width direction are provided between the first extraction part 52′a and the second extraction part 52′b of the first conductor layer 52′, specifically at positions with a gap being defined therebetween in the length direction, and two narrow parts 52′d having a function of increasing an inductance value by the slits 52′c in the width direction are provided on the other side in the width direction.

The second conductor layer 53′ has a rectangular shape of the size identical to that of the first conductor layer 52′, and a third extraction part 53′a and a fourth extraction part 53′b are provided on the other side in a width direction of the second conductor layer 53′ with a gap being defined therebetween in a length direction. Also, two slits 53′c in the width direction are provided between the third extraction part 53′a and the fourth extraction part 53′b of the second conductor layer 53′, specifically at positions with a gap being defined therebetween in the length direction, and two narrow parts 53′d having a function of increasing an inductance value by the slits 53′c in the width direction are provided on one side in the width direction.

The first conductor layer 52′ has a structure wherein three partial conductor layers A1, A2, and A3 each having a rectangular shape are joined with the narrow part 52′d having the inductance value increasing function being formed between the adjacent partial conductor layers, and the second conductor layer 53′ has a structure wherein three partial conductor layers B1, B2, and B3 each having a rectangular shape are joined with the narrow part 53′d having the inductance value increasing function being formed between the adjacent partial conductor layers. A dielectric layer is denoted by 51′.

In the case of using the first conductor layer 52′ and the second conductor layer 53′ in place of the first conductor layer 22 and the second conductor layer 23 shown in FIG. 6, an equivalent circuit of a multi-layer capacitor to be obtained is the same as that shown in FIG. 21D due to the three narrow parts 52′d and 53′d of the first conductor layer 52′ and the second conductor layer 53′. Such multi-layer capacitor achieves the effects same as those of the multi-layer capacitor 10 and the integrated circuit described in the foregoing. Though the example wherein the narrow parts 52′d are provided on the other side in width direction while providing the narrow parts 53′d on one side in width direction has been described in this modification example, the positions may be reversed. Also, this modification example is applicable to the twelfth and the thirteenth modification examples described later in this specification.

### Tenth Modification Example of First and Second Conductor Layers

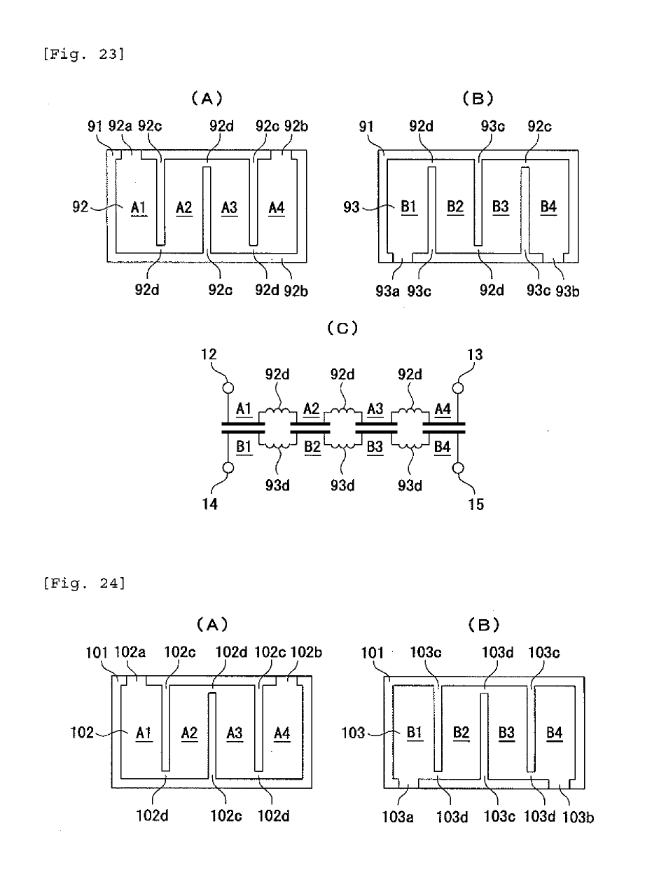

FIGS. 23A to 23C are diagrams showing a twelfth modification example of the first conductor layer and the second conductor layer shown in FIG. 6, wherein FIG. 23A is a top view showing the first conductor layer; FIG. 23B is a top view of the second conductor layer; and FIG. 23C is a diagram showing an equivalent circuit of a laminated condense obtained by using the first conductor layer and the second conductor layer shown in FIGS. 23A and 23B.

The first conductor layer 92 has a rectangular shape having a predetermined length and a predetermined width and provided with a first extraction part 92a and a second extraction part 92b disposed at one side in a width direction of the first conductor layer 92 with a gap being defined therebetween in a length direction. Also, three slits 92c in the width direction are provided between the first extraction part 92a and the second extraction part 92b of the first conductor layer 92, specifically at positions with a gap being defined between the adjacent slits in the length direction, and three narrow parts 92d having a function of increasing an inductance value by the slits 92c in the width direction are provided on the other side in the width direction, one side in the width direction, and the other side in the with direction in this order.

The second conductor layer 93 has a rectangular shape of the size identical to that of the first conductor layer 92, and a third extraction part 93a and a fourth extraction part 93b are provided on one side in a width direction of the second conductor layer 93 with a gap being defined therebetween in a length direction. Also, three slits 93c in the width direction are provided between the third extraction part 93a and the fourth extraction part 93b of the second conductor layer 93, specifically at positions substantially corresponding in the length direction to the slits 92c of the first conductor layer 92, and three narrow parts 93d having a function of increasing an inductance value by the slits 93c in the width direction are provided on one side in the width direction, the other side in the width direction, and one side in the width direction in this order.

The first conductor layer 92 has a structure wherein four partial conductor layers A1, A2, A3, and A4 each having a rectangular shape are joined with the narrow part 92d having the inductance value increasing function being formed between the adjacent partial conductor layers, and the second conductor layer 93 has a structure wherein four partial conductor layers B1, B2, B3, and B4 each having a rectangular shape are joined with the narrow part 93d having the inductance value increasing function being formed between the adjacent partial conductor layers. A dielectric layer is denoted by 91.

In the case of using the first conductor layer 92 and the second conductor layer 93 in place of the first conductor layer 22 and the second conductor layer 23 shown in FIG. 6, an equivalent circuit of a multi-layer capacitor to be obtained is the same as that shown in FIG. 23C due to the three narrow parts 92d and 93d of the first conductor layer 92 and the second conductor layer 93. Such multi-layer capacitor achieves the effects same as those of the multi-layer capacitor 10 and the integrated circuit described in the foregoing.

### Eleventh Modification Example of First and Second Conductor Layers

FIGS. 24A and 24B are diagrams showing a thirteenth modification example of the first conductor layer and the second conductor layer shown in FIG. 6, wherein FIG. 24A is a top view showing the first conductor layer; and FIG. 24B is a top view of the second conductor layer.

The first conductor layer 102 has a rectangular shape having a predetermined length and a predetermined width and provided with a first extraction part 102a and a second extraction part 102b disposed at one side in a width direction of the first conductor layer 102 with a gap being defined therebetween in a length direction. Also, four slits 102c in the width direction are provided between the first extraction part 102a and the second extraction part 102b of the first conductor layer 102, specifically at positions with a gap being defined between the adjacent slits in the length direction, and three narrow parts 102d having a function of increasing an inductance value by the slits 102c in the width direction are provided on the other side in the width direction, one side in the width direction, and the other side in the with direction in this order.

The second conductor layer 103 has a rectangular shape of the size identical to that of the first conductor layer 102, and a third extraction part 103a and a fourth extraction part 103b are provided on the other side in a width direction of the second conductor layer 103 with a gap being defined therebetween in a length direction. Also, three slits 103c in the width direction are provided between the third extraction part 103a and the fourth extraction part 103b of the second conductor layer 103, specifically at positions substantially corresponding in the length direction to the slits 102c of the first conductor layer 102, and three narrow parts 103d having a function of increasing an inductance value by the slits 103c in the width direction are provided on the other side in the width direction, one side in the width direction, and the other side in the width direction in this order. The positions in the length direction and in the width direction of the three narrow parts 103d are substantially identical with the positions in the length direction and the width direction of the three narrow parts 102d of the first conductor layer 102.

The first conductor layer 102 has a structure wherein four partial conductor layers A1, A2, A3, and A4 each having a rectangular shape are joined with the narrow part 102d having the inductance value increasing function being formed between the adjacent partial conductor layers, and the second conductor layer 103 has a structure wherein four partial conductor layers B1, B2, B3, and B4 each having a rectangular shape are joined with the narrow part 103d having the inductance value increasing function being formed between the adjacent partial conductor layers. A dielectric layer is denoted by 101.

It is possible to obtain a multi-layer capacitor having an equivalent circuit same as that shown in FIG. 23C by using the first conductor layer 102 and the second conductor layer 103 in place of the first conductor layer 22 and the second conductor layer 23 shown in FIG. 6, and such multi-layer capacitor achieves the effects same as those of the multi-layer capacitor 10 and the integrated circuit described in the foregoing.

### Twelfth Modification Example of First and Second Conductor Layers

FIGS. 25A and 25B are diagrams showing a twelfth modification example of the first conductor layer and the second conductor layer shown in FIG. 6, wherein FIG. 25A is a top view showing the first conductor layer; and FIG. 25B is a top view of the second conductor layer.

The first conductor layer 72′ has a rectangular shape having a predetermined length and a predetermined width and provided with a first extraction part 72′a and a second extraction part 72′b disposed at one side in a width direction of the first conductor layer 72′ with a gap being defined therebetween in a length direction. Also, a slit 72′c in the width direction is provided between the first extraction part 72′a and the second extraction part 72′b of the first conductor layer 72′, specifically at positions with a gap being defined therebetween in the length direction, and a slit 72′e in the length direction is joined with the slit 72′c in the width direction in such a fashion as to intersect the slit 72′c in the width direction, thereby forming a slit having a substantially cruciform. Three narrow parts 72′d having a function of increasing an inductance value by the slit 72′c in the width direction and the slit 72′e in the length direction are provided, among which two narrow parts 72′d are disposed on both sides in the length direction, and the remaining one narrow part 72′d is disposed on the other side in the width direction.

The second conductor layer 73′ has a rectangular shape of the size identical to that of the first conductor layer 72′, and a third extraction part 73′a and a fourth extraction part 73′b are provided on the other side in a width direction of the second conductor layer 73′ with a gap being defined therebetween in a length direction. Also, a slit 73′c in the width direction is provided between the third extraction part 73′a and the fourth extraction part 73′b of the second conductor layer 73′, specifically at a position substantially corresponding in the length direction to the slit 72′c in the width direction of the second conductor layer 73′, and a slit 73′e in the length direction is joined with the slit 73′c in the width direction in such a fashion as to intersect the slit 73′c in the width direction, thereby forming a slit having a substantially cruciform. Three narrow parts 73′d having a function of increasing an inductance value by the slit 73′c in the width direction and the slit 73′e in the length direction are provided, among which two narrow parts 73′d are disposed on both sides in the length direction, and the remaining one narrow part 73′d is disposed on one side in the width direction.

The first conductor layer 72′ has a structure wherein four partial conductor layers A1, A2, A3, and A4 each having a rectangular shape are joined via the narrow parts 72′d having the inductance value increasing function, and the second conductor layer 73′ has a structure wherein four partial conductor layers B1, B2, B3, and B4 each having a rectangular shape are joined via the narrow parts 73′d having the inductance value increasing function. A dielectric layer is denoted by 71′.

It is possible to obtain a multi-layer capacitor having an equivalent circuit same as that shown in FIG. 23C by using the first conductor layer 72′ and the second conductor layer 73′ in place of the first conductor layer 22 and the second conductor layer 23 shown in FIG. 6, and such multi-layer capacitor achieves the effects same as those of the multi-layer capacitor 10 and the integrated circuit described in the foregoing.

### Second Embodiment

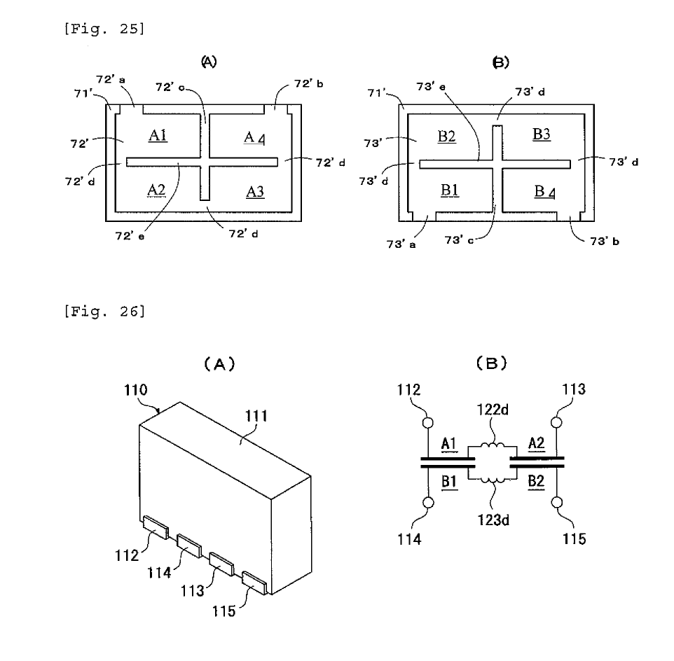

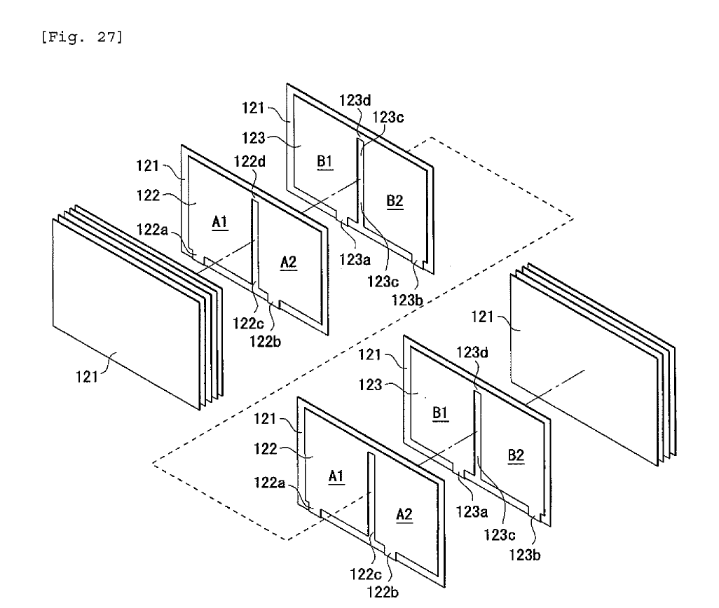

Shown in FIGS. 26A, 26B and 27 are multi-layer capacitors, wherein FIG. 26A is a perspective view showing an appearance of the multi-layer capacitor; FIG. 26B is a diagram showing an equivalent circuit of the multi-layer capacitor shown in FIG. 26A; and FIG. 27 is a broken perspective view showing an internal structure of a main body shown in FIG. 26A.

A multi-layer capacitor 110 of the second embodiment is different from the multi-layer capacitor 10 of the first embodiment in that a first conductor layer and a second conductor layer are laminated in a horizontal direction, and that all of first to fourth external electrodes are disposed at one side.

The multi-layer capacitor 110 shown in the drawings is provided with a main body 111 in the form of a rectangular parallelepiped having a predetermined length, a predetermined width, and a predetermined height; and a first external electrode 112 and a second external electrode 113 having one of the polarities and a third external electrode 114 and a fourth external electrode 115 having the other polarity, the first to fourth external electrodes being disposed at one side of an obverse surface of the main body 11 with a gap being defined between the adjacent external electrodes.

The main body 111 has a structure wherein a first conductor layer 122 having a first extraction part 122a and a second extraction part 122b and a second conductor layer 123 having a third extraction part 123a and a fourth extraction part 123b are alternately and integrally laminated in a horizontal direction via a dielectric layer 121.

Each of the first conductor layers 122 has a rectangular shape having a predetermined length and a predetermined width (height), and the first extraction part 122a and the second extraction part 122b are provided on one side in a height direction of the first conductor layer 122 with a gap being defined therebetween in a length direction. Also, a slit 122c in the height direction is provided between the first extraction part 122a and the second extraction part 122b of the first conductor layer 122, specifically at the center in the length direction, and a narrow part 122d having a function of increasing an inductance value by the slit 122c in the height direction is provided on the other side in the height direction.

Each of the second conductor layers 123 has a rectangular shape of the size identical to that of the first conductor layer 122, and the third extraction part 123a and the fourth extraction part 123b are provided on one side in a height direction of the second conductor layer 123 with a gap being defined therebetween in a length direction so that they do not intersect with the first extraction part 122a and the second extraction part 122b. Also, a slit 123c in the width direction is provided between the third extracting part 123a and the fourth extraction part 123b of the second conductor layer 123, specifically at a position substantially corresponding in the length direction to the slit 122c in the width direction of each of the first conductor layer 122, and a narrow part 123d functioning as an inductor by the slit 123c in the width direction is provided on the other side in the height direction. The position in the length direction and the position in the height direction of the narrow part 123d are substantially the same as those of the narrow part 122d of the first conductor layer 122.

Each of the first conductor layers 122 has a structure wherein two partial conductor layers A1 and A2 each having a rectangular shape are joined via one narrow part 122d having the inductance value increasing function, and each of the second conductor layers 123 has a structure wherein two partial conductor layers B1 and B2 each having a rectangular shape are joined via one narrow part 123d having the inductance value increasing function. Since each of the extraction parts 122a is connected to the first external electrode 112; each of the second extraction parts 122b is connected to the second external electrode 113; each of the third extraction parts 123a is connected to the third external electrode 114; and each of the fourth extraction parts 123b is connected to the fourth external electrode 115, an equivalent circuit of the multi-layer capacitor 110 is as shown in FIG. 26B.

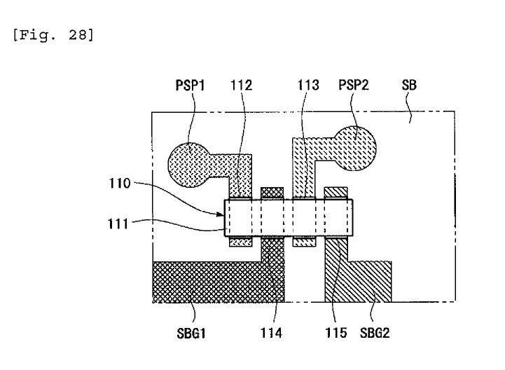

FIG. 28 is a diagram showing a mounting example of the multi-layer capacitor 110 shown in FIG. 26A, wherein SB is a circuit substrate; PSP1 is a substrate power supply pattern; PSP2 is an IC power supply pattern; and SBG1 is a substrate ground pattern, and SBG2 is an IC ground pattern. Shown in FIG. 28 is a reverse surface of the circuit substrate SB on which an integrated circuit (not shown) is mounted, and a power supply terminal of the integrated circuit is connected to an IC power supply pattern (not shown) on an obverse surface that is in conduction with the IC power supply pattern PSP2 on the reverse surface, and a ground terminal of the integrated circuit is connected to an IC ground pattern (not shown) of the obverse surface that is in conduction with the IC ground pattern SBG2 on the reverse surface.

The first external electrode 112 of the multi-layer capacitor 110 is connected to the substrate power supply pattern PSP1; the second external electrode 113 is connected to the IC power supply pattern PSP2; and the third external electrodes 114 is connected to the substrate ground pattern SBG1; and the fourth external electrodes 115 is connected to the IC ground pattern SBG2.

In the mounting example of the multi-layer capacitor 110 shown in FIG. 28, a noise current leaked out from the power supply terminal of the integrated circuit IC flows into each of the first conductor layers 112 and bypassed from each of the second conductor layers 123 of the multi-layer capacitor 110 to the substrate ground pattern SBG1 and the IC ground pattern SBG2 through the IC power supply pattern PSP2. Therefore, a power supply line noise caused by the noise current flown to the substrate power supply pattern PSP1 is suppressed.

Noise suppression characteristic according to the mounting example of FIG. 28 is substantially the same as that shown in FIG. 8. In the multi-layer capacitor 110, each of the first conductor layers 122 has the narrow part 122d having the inductance increasing function, and each of the second conductor layers 123 has the narrow part 123d having the inductance increasing function as is apparent from the equivalent circuit of FIG. 26B. Since a pattern-dependent inductance component is reduced thanks to the patterns that are designed in accordance with the positions of the first to fourth external electrodes 112 to 115, it is possible to obtain better noise suppression characteristic at a wider frequency band as compared to the case of using an ordinary capacitor (see broken line in FIG. 8).

In order to form an integrated circuit module same as that shown in FIGS. 9 and 10 by using the multi-layer capacitor 110, the substrate power supply pattern PSP1, the IC power supply pattern PSP2, the substrate ground pattern SBG1, and the IC ground pattern SBG2 provided on the reverse side of the circuit substrate SB are modified in accordance with the positions of the first to fourth external electrodes 112 to 115 so as to obtain the connection relationship shown in FIG. 28.

Effects achieved by the multi-layer capacitor 110 and the integrated circuit using the multi-layer capacitor 110 are the same as those achieved by the above-described circuit device on which the multi-layer capacitor 10 and the integrated circuit are mounted.

The object, structure, and effects of this invention are not limited to the foregoing description, and it is possible to make various modifications within the scope not departing from the spirit of this invention. For example, a circuit current flows in the four-terminal multi-layer capacitor of the foregoing embodiments, and un upper limit of the current is decided by a size and an electrode structure of the four-terminal multi-layer capacitor. Therefore, a plurality of parallelly arranged capacitors are used when the current exceeds the upper limit. In such case, electrodes forming a capacitor having the above-described four-terminal structure may be formed, so that the capacitor is used as a multi-terminal array capacitor. For example, it is possible to use an array having two four-terminal capacitors as an eight-terminal capacitor.

What is claimed is:

1. A multi-layer capacitor comprising a first external electrode and a second external electrode and a third electrode and a fourth electrode on an obverse surface of a main body, wherein
the main body has a structure that a first conductor layer having a first extraction part connected to the first external electrode and a second extraction part connected to the second external electrode and a second conductor layer having a third extraction part connected to the third external electrode and a fourth extraction part connected to the fourth external electrode are alternately and integrally laminated via a dielectric layer; and
at least one of the first and the second conductor layer has a structure that two or more partial conductor layers are joined via at least one narrow part.

2. The multi-layer capacitor according to claim 1, wherein
the first conductor layer has a structure of being divided into two or more partial conductor layers that are joined via at least one narrow part; and
the second conductor layer has a structure of being divided into two or more partial conductor layers that are joined via at least one narrow part.

3. The multi-layer capacitor according to claim 2, wherein
each of the first and the second conductor layers forms a rectangle having a predetermined length and a predetermined width;
the first extraction part and the second extraction part are disposed on one side in a width direction of the first conductor layer with a gap being defined therebetween in a length direction;
the third extraction part and the fourth extraction part are disposed on the other side in a width direction of the second conductor layer with a gap being defined therebetween in a length direction;
the first conductor layer is provided with one narrow part disposed at the other side in the width direction by one slit in the width direction disposed between the first extraction part and the second extraction part;
the second conductor layer is provided with one narrow part disposed at one side in the width direction by one slit in the width direction disposed between the third extraction part and the fourth extraction part; and
a position of the slit in the width direction of the first conductor layer and a position of the slit in the width direction of the second conductor layer are substantially identical with each other in the length direction.

4. The multi-layer capacitor according to claim 3, wherein
the slit in the width direction of the first conductor layer is disposed at a position close to the first extraction part; and
the corresponding slit in the width direction of the second conductor layer is disposed at a position close to the third extraction part.

5. The multi-layer capacitor according to claim 2, wherein
each of the first and the second conductor layers forms a rectangle having a predetermined length and a predetermined width;
the first extraction part and the second extraction part are disposed on one side in a width direction of the first conductor layer with a gap being defined therebetween in a length direction;
the third extraction part and the fourth extraction part are disposed on the other side in a width direction of the second conductor layer with a gap being defined therebetween in a length direction;
the first conductor layer is provided with one narrow part disposed at one side in the width direction by one slit in the width direction disposed between the first extraction part and the second extraction part;
the second conductor layer is provided with one narrow part disposed at the other side in the width direction by one slit in the width direction disposed between the third extraction part and the fourth extraction part; and
a position in the length direction of the slit in the width direction of the first conductor layer and a position in the length direction of the slit in the width direction the second conductor layer are substantially identical with each other.

6. The multi-layer capacitor according to claim 2, wherein
each of the first and the second conductor layers forms a rectangle having a predetermined length and a predetermined width;
the first extraction part and the second extraction part are disposed on one side in a width direction of the first conductor layer with a gap being defined therebetween in a length direction;
the third extraction part and the fourth extraction part are disposed on the other side in a width direction of the second conductor layer with a gap being defined therebetween in a length direction;
the first conductor layer is provided with one narrow part disposed at a center in the width direction by two slits in the width direction disposed opposed to each other between the first extraction part and the second extraction part;
the second conductor layer is provided with one narrow part disposed at a center in the width direction by two slits in the width direction disposed opposed to each other between the third extraction part and the fourth extraction part;
positions of the two slits in the width direction of the first conductor layer and positions of the two slits in the width direction of the second conductor layer are substantially identical with each other in the length direction; and
a position of the narrow part of the first conductor layer and a position of the narrow part of the second conductor layer are substantially identical with each other in the length direction and the width direction.

7. The multi-layer capacitor according to claim 2, wherein
each of the first and the second conductor layers forms a rectangle having a predetermined length and a predetermined width;
the first extraction part and the second extraction part are disposed on one side in a width direction of the first conductor layer with a gap being defined therebetween in a length direction;
the third extraction part and the fourth extraction part are disposed on the other side in a width direction of the second conductor layer with a gap being defined therebetween in a length direction;
the first conductor layer is provided with narrow parts disposed at one side and the other side in the width direction by an independent slit in the width direction disposed between the first extraction part and the second extraction part;
the second conductor layer is provided with narrow parts disposed at one side and the other side in the width direction by an independent slit in the width direction disposed between the third extraction part and the fourth extraction part;
a position of the slit in the width direction of the first conductor layer and a position of the slit in the width direction of the second conductor layer are substantially identical with each other in the length direction; and
positions of the two narrow parts of the first conductor layer and positions of the two narrow parts of the second conductor layer are substantially identical with each other in the length direction and the width direction.

8. The multi-layer capacitor according to claim 2, wherein
the first conductor layer has a structure of being divided into three partial conductor layers, and the three partial conductor layers are joined with one another with at least one narrow part being provided between the adjacent particle conductor layers; and
the second conductor layer has a structure of being divided into three partial conductor layers, and the three partial conductor layers are joined with one another with at least one narrow part being provided between the adjacent particle conductor layers.

9. The multi-layer capacitor according to claim 8, wherein
each of the first and the second conductor layers forms a rectangle having a predetermined length and a predetermined width;
the first extraction part is disposed on one side in a width direction of the first conductor layer in the vicinity of one side in a length direction;
the second extraction part is disposed on the other side in the width direction of the first conductor layer in the vicinity of the other side in the length direction;
the third extraction part is disposed on the other side in a width direction of the second conductor layer in the vicinity of one side in a length direction;
the fourth extraction part is disposed on one side in the width direction of the second conductor layer in the vicinity of the other side in the length direction;
the first conductor layer is provided with two narrow parts disposed at one side and the other side in the width direction by two slits in the width direction disposed between the first extraction part and the second extraction part with a gap being defined therebetween in the length direction;
the second conductor layer is provided with two narrow parts disposed at one side and the other side in the width direction by two slits in the width direction disposed between the third extraction part and the fourth extraction part with a gap being defined therebetween in the length direction; and
positions of the slits in the width direction of the first conductor layer and positions of the slits in the width direction of the second conductor layer are substantially identical with each other in the length direction.

10. The multi-layer capacitor according to claim 2, wherein
the first conductor layer has a structure of being divided into four partial conductor layers and the four partial conductor layers are joined with one another with at least one narrow part being provided between the adjacent particle conductor layers; and
the second conductor layer has a structure of being divided into four partial conductor layers and the four partial conductor layers are joined with one another with at least one narrow part being provided between the adjacent particle conductor layers.

11. The multi-layer capacitor according to claim 10, wherein
each of the first and the second conductor layers forms a rectangle having a predetermined length and a predetermined width;
the first extraction part and the second extraction part are disposed on one side in a width direction of the first conductor layer with a gap being defined therebetween in a length direction;
the third extraction part and the fourth extraction part are disposed on the other side in a width direction of the second conductor layer with a gap being defined therebetween in a length direction;
the first conductor layer is provided with three narrow parts disposed at one side and the other side in the width direction by three slits in the width direction disposed between the first extraction part and the second extraction part with a gap being defined between the adjacent slits;
the second conductor layer is provided with three narrow parts disposed at one side and the other side in the width direction by three slit in the width direction disposed between the third extraction part and the fourth extraction part with a gap being defined between the adjacent slits; and
positions of the slits in the width direction of the first conductor layer and positions of the slits in the width direction of the second conductor layer are substantially identical with each other in the length direction.

12. A circuit device on which an integrated circuit is mounted, comprising:
a circuit substrate provided with a substrate power supply pattern; an IC power supply pattern to which a power supply terminal of the integrated circuit is connected, a substrate ground pattern, and an IC ground pattern to which a ground terminal of the integrated circuit is connected; and
a multi-layer capacitor comprising a first external electrode and a second external electrode and a third external electrode and a fourth external electrode on an obverse surface of a main body, wherein
the main body has a structure that a first conductor layer having a first extraction part connected to the first external electrode and a second extraction part connected to the second external electrode and a second conductor layer having a third extraction part connected to the third external electrode and a fourth extraction part connected to the fourth external electrode are alternately and integrally laminated via a dielectric layer; and
at least one of the first and the second conductor layer has a structure that two or more partial conductor layers are joined via at least one narrow part;
wherein the first external electrode is connected to the substrate power supply pattern of the circuit substrate; the second external electrode is connected to the IC power supply pattern; the third external electrode is connected to the substrate ground pattern; and the fourth external electrode is connected to the IC ground pattern.
